(19) United States
(12) Patent Application Publication
(10) Pub. No.: US 2010/0300978 A1
(43) Pub. Date: Dec. 2, 2010

(54) DEVICE, SYSTEM AND METHOD FOR WASHING AND ISOLATING MAGNETIC PARTICLES IN A CONTINOUS FLUID FLOW

(75) Inventors: Qasem Ramadan, Singapore (SG); Liang Zhu, Singapore (SG); Hongmiao Ji, Singapore (SG); Wen-Tso Liu, Singapore (SG)

Correspondence Address: Milstein Zhang & Wu LLC, 49 Lexington Street, Suite 6, Newton, MA, 02465-1062, US

(73) Assignee: AGENCY FOR SCIENCE, TECHNOLOGY AND RESEARCH, Singapore (SG)

(21) Appl. No.: 12/679,013

(22) PCT Filed: Sep. 19, 2007
(86) PCT No.: PCT/SG2007/000316

§ 371 Date: Aug. 10, 2010

(51) Int. Cl. B03C 1/02

(52) U.S. Cl. 210/695; 210/222

(57) ABSTRACT

A device for washing and isolating magnetic particles from a continuous fluid flow in at least one fluidic channel having an inlet at one end and an outlet at another end, said device comprising at least one magnetic source carrier arranged proximate to the at least one fluidic channel. The at least one magnetic source carrier is moveable between a first position and a second position. The at least one magnetic source carrier comprises at least one first magnetic source, wherein a movement of the at least one magnetic source carrier to the first position places the at least one first magnetic source at a first spatial location along the at least one fluidic channel such that said at least one first magnetic source generates a maxima magnetic field at said first spatial location that attracts the magnetic particles from the continuous fluid flow and assembles said magnetic particles at said first spatial location. A movement of the at least one magnetic source carrier to the second position places the at least one first magnetic source distal from the first spatial location such that said magnetic field at said first spatial location is at a minima and the magnetic particles disperse from said first spatial location.

The present invention relates to the field of magnetic separation systems, and specifically, to a device, system and a method of washing and isolating magnetic particles from a continuous fluid flow in at least one fluidic channel having an inlet at one end and an outlet at another end.

In many bio-analytical assays magnetic nano and/or micro particles are used as a solid phase carrier for bio-analyzed targets (also known as analytes including, but not limited to, cells, DNA, RNA, mRNA and proteins, for example). In the course of said bio-analytical assays, the solid phase, including its analyte attached thereto, is typically separated from the liquid phase in which it is contained in, and is subsequently washed in a buffer solution, for example.

Conventional methods of washing the solid phase include pipetting a defined amount of buffer solution into a reaction vessel containing the solid phase to suspend the solid phase in the buffer solution. This is followed by a suction step that separates the solid phase from the liquid phase. During the suspension and suction steps mentioned above, a washing cycle of the solid phase takes place, and if needed, said steps are repeated to carry out a required ‘n’ number of cycles till the analyte is of a suitable purity. Each washing cycle usually includes the steps of carrying out a suspension of the solid phase, a separation (via suction) of the solid phase from the buffer solution and an aspiration.

Magnetic separation of an analyte from a solution using magnetic particles as the solid phase is another well known and popular method employed in many biological assays such as immunoassays, nucleic acid hybridization assays and sample purification assays, for example. In these assays, it is common to use the magnetic particles in connection with a reagent. The magnetic particles are typically coated with the reagent, which has a specific affinity for a targeted analyte. Subsequently, once the magnetic particle coated with the reagent is introduced into a solution containing the analyte, the reagent coating on the magnetic particle forms a complex with the target analyte thereby binding the target analyte to the magnetic particle. Following this, the magnetic particles (and its attached analyte) are separated from the solution using a permanent and/or electro magnet. The magnetic particles are then typically washed, and further separated in another medium or alternatively, the targeted analyte may be removed from the magnetic particles for further analysis.

One example of an automated magnetic separation device is disclosed in U.S. Pat. No. 5,536,475. This device includes both a means for a stationary capture of magnetic particles followed by a capture of magnetic particles during continuous flow. The device also includes a means for collecting most of the magnetic particles in a stationary reservoir above a first magnet. The remaining solution is then channeled over a second magnet to remove any magnetic particles that may not have been captured by the first magnet.

Another example of a magnetic particle separation device is disclosed in international application WO92/05443A. This application describes a device for separating magnetic particles from a plurality of reaction vessels, each of which contain a mixture (that includes magnetic particles) in a static state. The reaction vessels containing the magnetic particles are positioned in an array. The array is supported by a supporting means. Also included in the support is an array of stationary permanent magnets arranged such that each magnet exerts a magnetic force on a specific reaction vessel, thereby holding the magnetic particles in said reaction vessels at a fixed position relative to the permanent magnets. Following the fixing step of the magnetic particles, the remaining mixture may be removed from the reaction vessels thereby leaving behind the magnetic particles and the analyte attached thereto.

Another magnetic particle separation device is disclosed in U.S. Pat. No. 6,159,378. This magnetic particle separation device employs a stationary magnetic flux conductor made of monolithic porous foam. The magnetic flux conductor is permeable and thus, permits magnetic particles and fluid to flow through it. The magnetic flux conductor is magnetized by an external magnetic field from a permanent or an electromagnet and generates a magnetic field gradient within the magnetic flux conductor. When the magnetic field gradient is sufficiently high enough, the magnetic particles present in any fluid passing through the magnetic flux conductor are retained on walls of the porous foam. Conversely, when the magnetic field gradient is reduced to sufficiently low value the magnetic particles are allowed to pass through the magnetic flux conductor again.

Although the above-mentioned devices are capable of extracting magnetic particles with analyte attached thereto from mixtures, as many diagnostic tests are carried out after said extraction, it is necessary, as mentioned above, to wash the analyte in order to improve its purity. In this respect, the above—mentioned devices do not provide any means for washing the analyte obtained during the extraction process. As such, if the aforesaid devices are used, it is necessary to carry out subsequent washing steps before the analyte may be analyzed further. However, in carrying out said subsequent washing steps, there exists the necessity to repeat the washing steps several times to achieve an analyte with a high level of purity. In doing so, therein lies the risk that quantities of analyte may be lost during transfers between different washing containers, evaporation and adsorption to the wall of the containers during these washing steps.

In the case of a low concentration of analyte in the starting sample, carrying out the extraction and washing of said analyte as described above may cause the complete lose of analyte, or a sharp decrease in the amount such that it may become undetectable. Besides the above mentioned drawbacks, these washing steps (or additional manipulation methods) are expensive and expand a lot of time, which renders it unpractical in many industrial applications such as the detection of pathogenic micro organisms in biological, environmental or industrial samples, for example.

In order to overcome the aforesaid difficulties, PCT application WO 2002/43865 A discloses a method for separating magnetic particles from a mixture and a washing means. In this method, a solution where the analyte (attached to magnetic particles) is suspended in a first container connected via a bottle-neck to a second container. The analyte attached to the magnetic particles are dragged from the first container to the second container by a permanent magnet and the washing of the magnetic particles and its analyte then takes place in the second container.

Another such device is described in PCT application WO 2006/010584 A1. In this PCT application, the solution containing the analyte is contained in a reaction vessel with a large upper compartment having a funnel shape and an elongated lower compartment with a constant cross-sectional area. The process consists of subjecting the magnetic particles to two magnetic fields applied simultaneously to separate magnetic particles present in the upper compartment of the vessel from the fluid. This transfers magnetic particles from the upper part to the elongated lower compartment and removes the solution from the vessel. This is followed by adding washing buffer to the lower part. The rest of the washing buffer containing the magnetic particles is then subjected to two magnetic fields applied with different directions to wash the magnetic particles.

Further examples of magnetic particle separation devices are also disclosed in U.S. Pat. Nos. 6,346,196, 6,355,491, US patent application 2004/0023273, and PCT applications WO 2007/044642 A2 and WO 2006/021410 A1.

However, the aforesaid devices and/or processes still have drawbacks such as the capture the magnetic particles occurring only mainly at the walls of reservoirs, a low concentration of magnetic particles (which leads to low analyte yields) being captured, a general inability to release all the magnetic particles because of the residual magnetism that remain in the magnetic structures and finally, all the above devices require a lot of processing time before all the magnetic particles are separated from the liquid phase. In addition to the above difficulties, further disadvantages include a high loss of analyte during transfers from one container to another during the washing steps, and an inability to handle a large volume of samples.

As such, there still exists a need for a device for washing and isolating magnetic particles from a continuous fluid flow in at least one fluidic channel having an inlet at one end and an outlet at another end. Such a device should also be capable of being utilized together with existing laboratory infrastructure and be simple and yet cost-effective to implement. In this respect, the device, system and method, according to the present invention, of washing and isolating magnetic particles from a continuous fluid flow in at least one fluidic channel having an inlet at one end and an outlet at another end, overcomes the aforesaid difficulties.

The device of the present invention for washing and isolating magnetic particles from a continuous fluid flow in at least one fluidic channel having an inlet at one end and an outlet at another end includes at least one magnetic source carrier. The magnetic source carrier is arranged proximate to the at least one fluidic channel. The at least one magnetic source carrier is moveable between a first position and a second position and itself comprises at least one magnetic source. The magnetic source carrier does not move in a translational motion but rather rotates around its axis. A movement of the at least one magnetic source carrier to the first position places the at least one first magnetic source at a first spatial location along the at least one fluidic channel. In doing so, said at least one first magnetic source generates a maxima magnetic field at said first spatial location. The generated maxima magnetic field at the first spatial location attracts the magnetic particles from the continuous fluid flow and assembles said magnetic particles at said first spatial location. Conversely, a movement of the at least one magnetic source carrier to the second position places the at least one first magnetic source distal from the first spatial location such that said magnetic field at said first spatial location is at a minima, and the magnetic particles disperse from said first spatial location back into the continuous flow. The maxima magnetic field is between about 200 mT to about 500 mT. The minima magnetic field is between about 0 mT to about 50 mT.

In one exemplary embodiment, the at least one magnetic source carrier may further include at least one second magnetic source. In this exemplary embodiment, said at least one second magnetic source is arranged in a spatial arrangement with respect to the at least one first magnetic source such that the movement of the at least one magnetic source carrier to the second position places the at least one second magnetic source at a second spatial location along the fluidic channel. The second spatial location is located downstream from the first spatial location. The at least one second magnetic source generates a maxima magnetic field at said second spatial location. The generation of a maxima magnetic field at the second spatial location attracts the magnetic particles from the continuous fluid flow and assembles said magnetic particles at said second spatial location. The second magnetic source has a maxima magnetic field when the first magnetic source has a minima magnetic field. Therefore after the particles are released from the first position (when the first position has changed from a maxima magnetic field to a minima magnetic field) and flow downstream with the continuous flow, the particles will be trapped again at the second position where second position has changed from a minima magnetic field to a maxima magnetic field.

In this embodiment, it may be the case that the at least one magnetic source carrier moves again, to either a third position or back to the first position. In either case, the at least one second magnetic source is then distal to the second spatial location and hence generates a minima magnetic field at said second spatial location resulting in a dispersal of the magnetic particles assembled there. Concurrently, the at least one first magnetic source is then placed at the first spatial location along the at least one fluidic channel. In doing so, said at least one first magnetic source once again generates a maxima magnetic field at said first spatial location and that attracts the magnetic particles from the continuous fluid flow and assembles said magnetic particles at said first spatial location again.

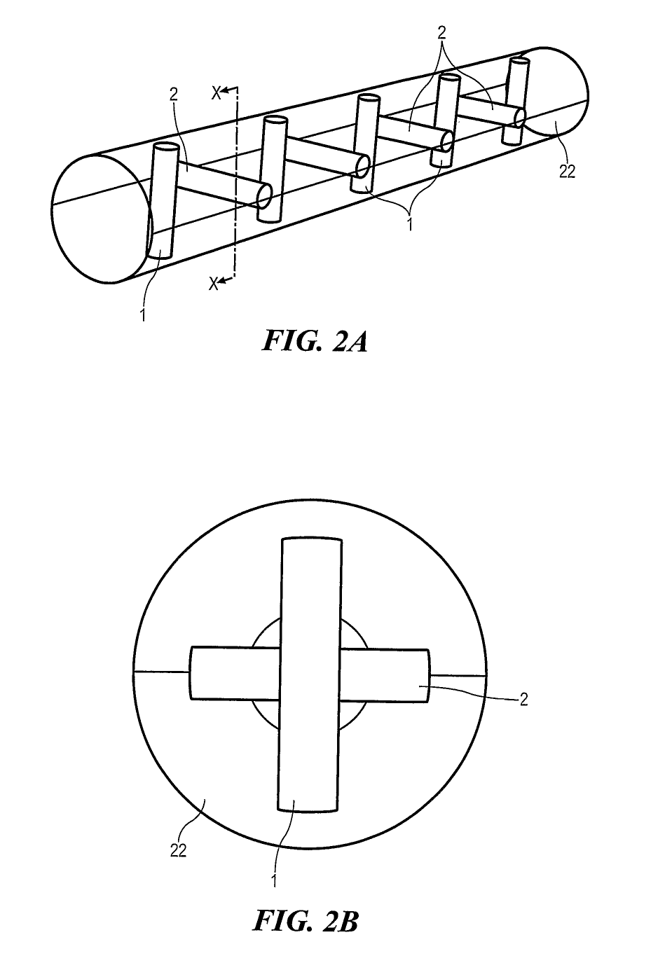

In one exemplary embodiment of the invention, the magnetic source carrier may include a cylinder. In this embodiment, the cylinder may be arranged proximate to the fluidic channel, such that the cylinder is moveable via a rotation about its central longitudinal axis. In this embodiment, the at least one magnetic source carrier, which is a cylinder, may include, as previously mentioned, at least one first magnetic source and at least one second magnetic source. Where there are two magnetic sources, the at least one first and second magnetic sources are in an equidistant alternating spatial arrangement with respect to each other along the central rotational axis of the cylinder. In addition, each of the at least one second magnetic source is oriented to be perpendicular to its adjacent at least one first magnetic source. This embodiment, especially the orientation of the magnetic sources, is further described in detail below with respect to FIG. 2a.

In another embodiment, the magnetic source carrier may include a disc arranged concentric (or simply directly beneath) to the fluidic channel. In this embodiment, the disc may be moveable via a rotation about its origin. The disc may include at least one circular ring and the at least one circular ring may include the at least one first magnetic source arranged along its circumference.

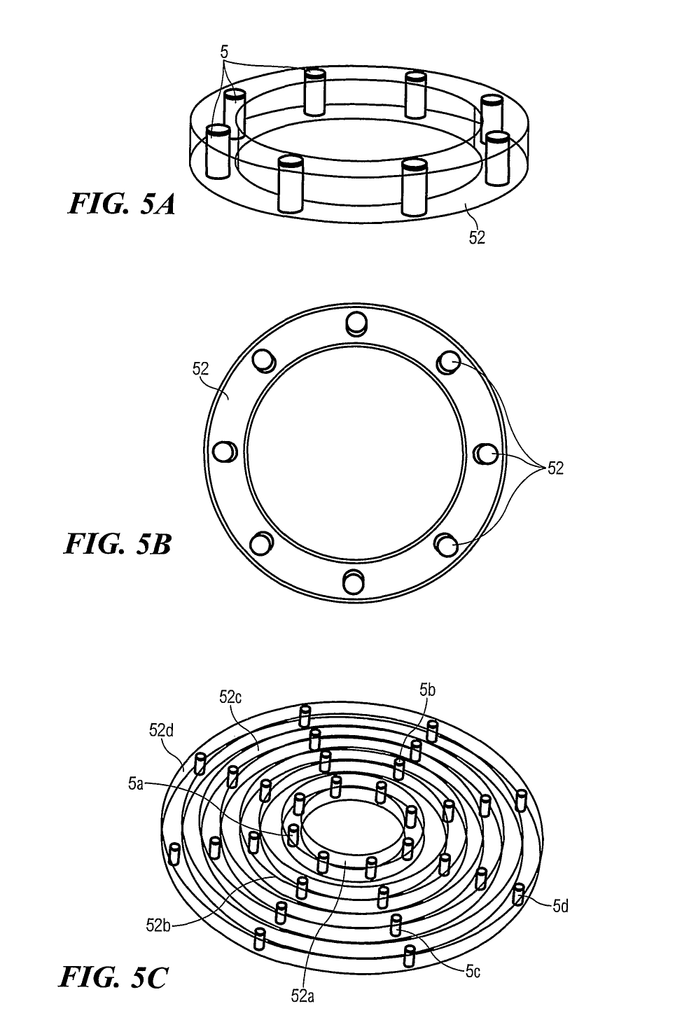

In another exemplary embodiment where the magnetic source carrier is a disc, the disc may further include another circular ring. In this embodiment, the another ring is arranged to be concentric to the at least one circular ring. The another circular ring includes the at least one second magnetic source arranged along its circumference as well. The at least one circular ring and the another circular ring may be moveable independent of each other or moveable as a single entity. This embodiment is further described in greater detail with respect to FIG. 5a-FIG. 5c below.

In yet another exemplary embodiment, the magnetic source carrier may include a platform arranged parallel to the fluidic channel. In this embodiment, the platform is moveable via an oscillation about a median axis. In this embodiment, the platform may include a first and a second magnetic source carriage arranged such that the fluidic channel is positioned in parallel between the first and second magnetic source carriage. In other words, the fluidic channel lies along the median axis about which the platform oscillates.

In the above embodiment where the platform includes a first and a second magnetic source carriage, the at least one first magnetic source may be arranged at discrete points along the first magnetic source carriage and the at least one second magnetic source may be arranged at discrete points along the second magnetic source carriage. The arrangement of each consecutive at least one first magnetic source is such that it is distal (opposite) to a gap between two consecutive at least one second magnetic sources of the second magnetic source carriage. The first and the second magnetic source carriages may be adapted to oscillate independently of each other or in unison. In any case, at any one time, only one magnetic source carriage is proximate to the fluidic channel.

All the preceding embodiments of the device of the invention may further include a motor that drives the movement of the magnetic source carrier. The motor may be an AC or a DC motor, for example. In the case of an AC motor, the motor may be a stepper motor, synchronous motor or an induction motor, for example. In the case of a DC motor, the motor may be a shunt wound motor, a series wound motor, a permanent magnet motor or a servomotor, for example.

In addition, all the embodiments as described above may also have the at least one first magnetic source and/or the at least one second magnetic source embedded within the at least one magnetic source carrier. Alternatively, the respective magnetic sources may be arranged on the surface of the magnetic source carrier. The at least one first and second magnetic sources may include permanent magnets or electromagnets, or a combination thereof, for example.

In addition to the above, all the preceding embodiments of the invention may also further include at least one capture magnetic source proximate to the outlet of the fluidic channel. The capture magnetic source is constant and does not vary as it is intended to capture all the magnetic particles having undergone the previous washing steps which are the result of the assembly and dispersal due to the varying magnetic fields.

Another aspect of the invention relates to a system for washing and isolating magnetic particles in a continuous fluid flow. The system essentially includes at least one fluidic channel having an inlet at one end and an outlet at another end and any one of the embodiments of the device of the invention as previously described.

In one embodiment of the system the at least one fluidic channel may be a straight channel that extends across the length of the device as previously described. In another embodiment, the channel may be a meandering shape. In yet another embodiment, the channel may have between two to four arms, for example, extending from a central core channel therefore effectively creating anywhere between two to four channels, each of which may be individually processed using any of the various embodiments of the device of the present invention previously described.

Yet another aspect of the present invention relates to a method of washing and isolating magnetic particles from a continuous fluid flow in at least one fluidic channel having an inlet at one end and an outlet at another end. The method includes the application of a magnetic field from a first magnetic source at a first spatial location along the fluidic channel. This attracts the magnetic particles from the continuous fluid flow and assembles said magnetic particles at the first spatial location. Subsequently the first magnetic source is moved relative to the fluidic channel such that the magnetic field at said first spatial position decreases sufficiently to result in a dispersal of the assembled magnetic particles from the first spatial location back into the continuous fluid flow.

The assembly and dispersal of the magnetic particles is analogous to the washing cycle as previously mentioned. During the assembly and dispersal of the magnetic particles, said magnetic particles rotate and oscillate as they move from a stationary position during assembly to a translational and rotational movement that includes oscillations. These movements during the dispersal of the magnetic particles have the effect of removing impurities that may be still attached to the analyte. Accordingly, the assembly and dispersal of the magnetic particles may be taken to constitute one washing cycle, which serves to improve the purity of the analyte.

In one embodiment, the above method may further include the application of a magnetic field from a second magnetic source at a second spatial location. The second spatial location is located downstream from the first spatial location along the fluidic channel. As in the application of the first magnetic field, the application of the second magnetic field attracts the magnetic particles from the continuous fluid flow and assembles said magnetic particles at the second spatial location. Subsequently, moving the second magnetic source relative to the fluidic channel such that the magnetic field at said second spatial position decreases sufficiently results in a dispersal of the assembled magnetic particles from the second spatial location back into the continuous fluid flow. This may be considered as an application of a second washing cycle. Using this same method, repeatedly, results in ‘n’ number of washing cycles being applied to the mixture containing the magnetic particles.

Both embodiments of the method as described above include the application of a magnetic field from an at least one capture magnetic source at a capture spatial location proximate to the outlet of the fluidic channel. The magnetic field from the capture magnet, as described above, is constant and attracts and assembles the magnetic particles from the continuous fluid flow at the capture spatial location. The constant magnetic field is necessary in order to facilitate the subsequent removal of said magnetic particles assembled at the capture spatial location so that the analyte attached thereto may be further processed.

Various aspects of the present invention will now be described with reference to the following illustrated exemplary embodiments of the present invention in which:

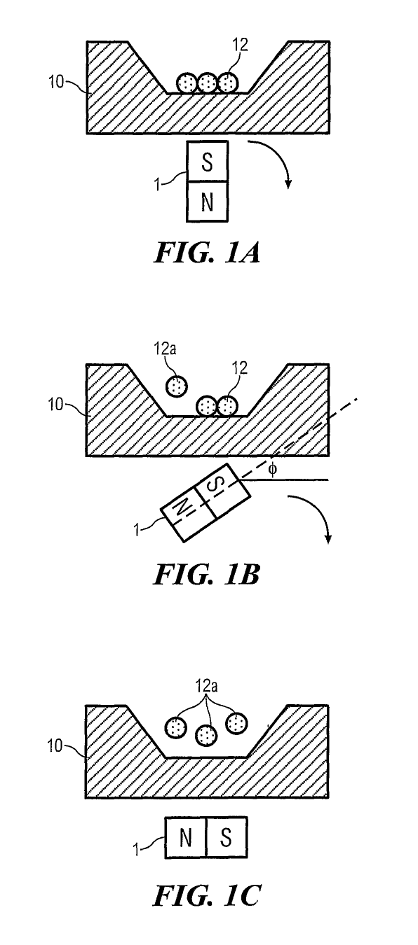

FIGS. 1a-1c shows the effects of different configurations of the channel-magnet pole interface and its corresponding effect on a magnetic particle within the channel;

FIG. 2a shows a cylindrical shaped magnetic source carrier with a number of magnetic sources inserted in it, each adjacent magnetic source being perpendicular to each other; FIG. 2b shows cross-sectional view about the line X-X of the cylindrical shaped magnetic source carrier of FIG. 2a;

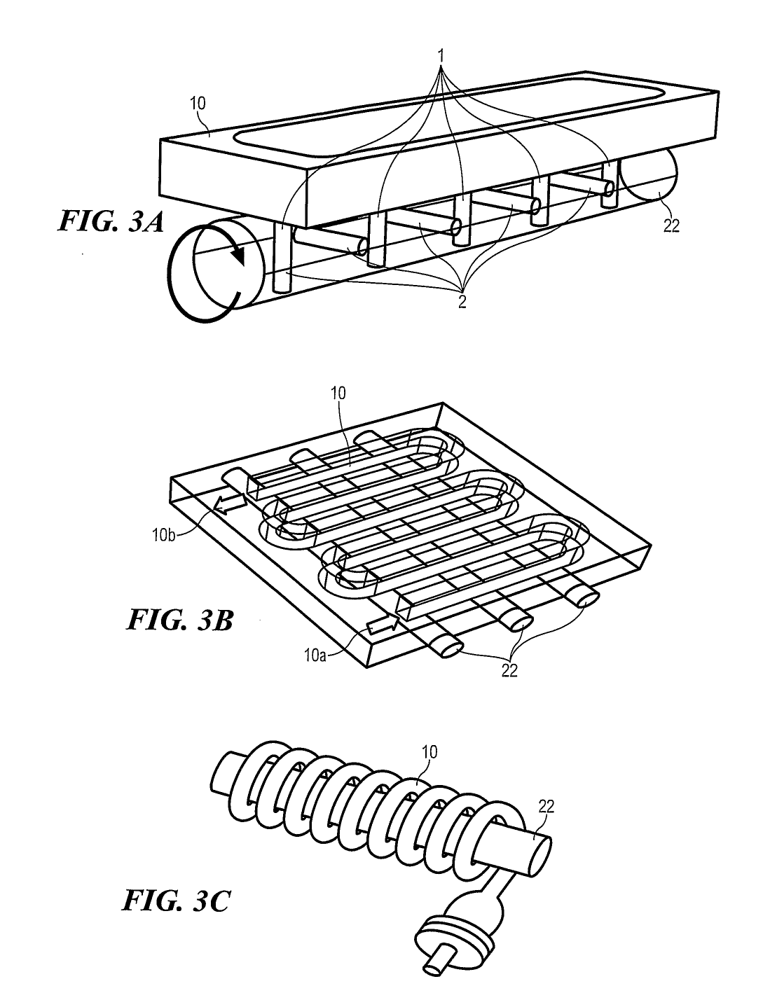

FIG. 3a shows a magnetic source carrier with a fluidic channel on top of it; FIG. 3b shows a meander shaped channel as used in conjunction with the magnetic source carrier of FIG. 2a; FIG. 3c shows a spiral shaped channel as used in conjunction with the magnetic source carrier of FIG. 2a;

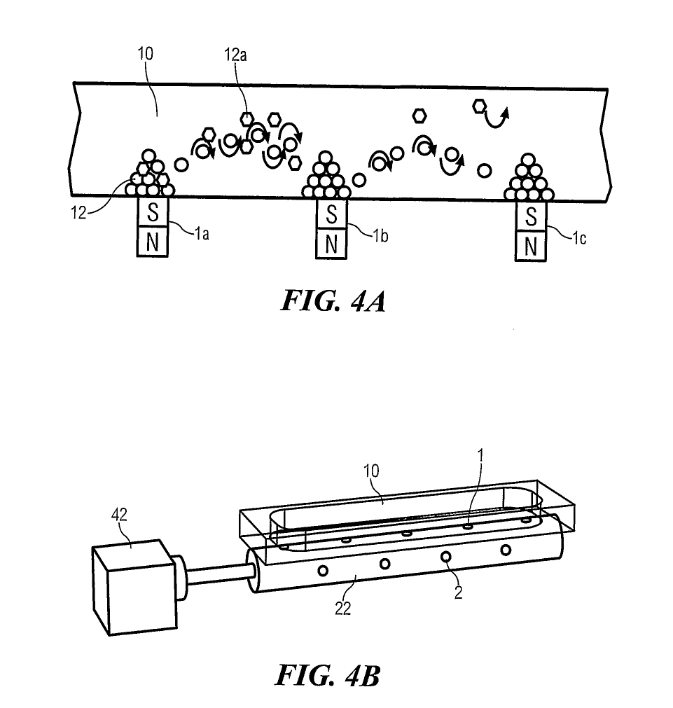

FIG. 4a shows a schematic illustration of a trapping and releasing sequence of magnetic particles due to a magnetic field; FIG. 4b is an illustration of a magnetic source carrier, a fluidic channel, and a motor to generate the spinning motion of the magnetic source carrier;

FIG. 5a is a circular shaped magnetic source carrier with a number of permanent magnet inserted in it; FIG. 5b is a top view of the magnetic source carrier of FIG. 5a; FIG. 5c illustrates concentric magnetic source carriers for programmable transport of magnetic particles;

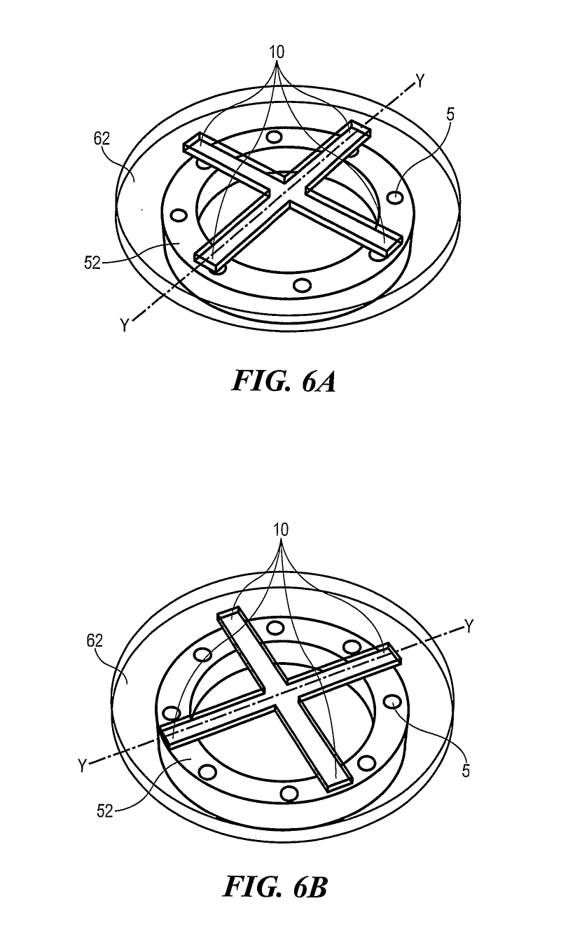

FIGS. 6a and 6b are illustrations of an embodiment of the invention;

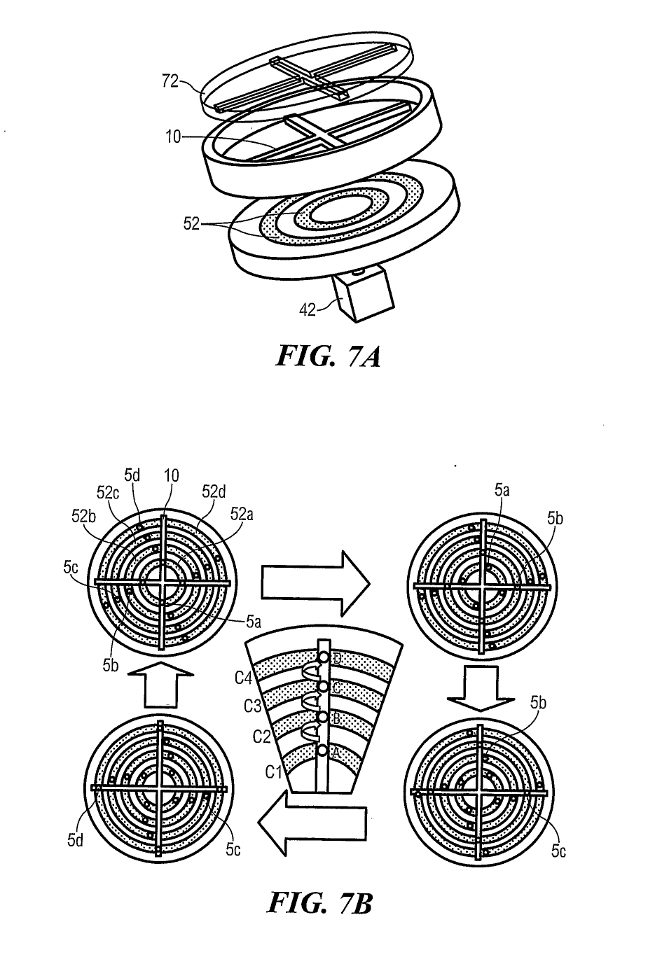

FIG. 7a illustrates an embodiment of the invention where the magnatic source carrier includes concentric rings, a fluidic channel and a motor to generate the rotation motion in the magnetic source carrier; FIG. 7b is a diagram that illustrates the washing and isolation sequence of magnetic particles as carried out by the embodiment of FIG. 7a;

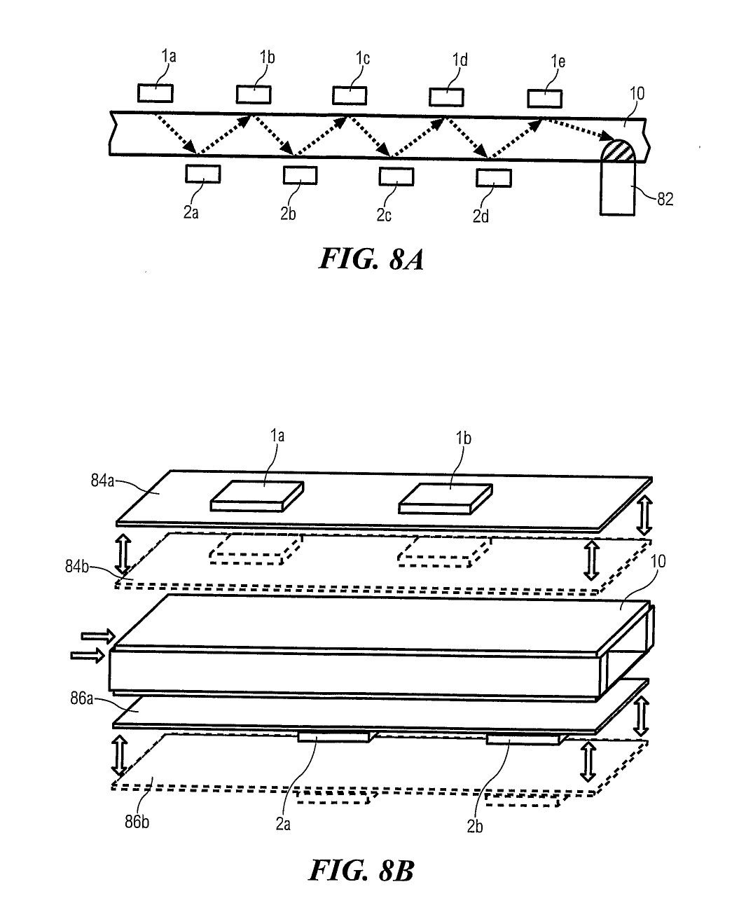

FIGS. 8a and 8b are a schematic diagram and an illustration, respectively, of another embodiment of the invention;

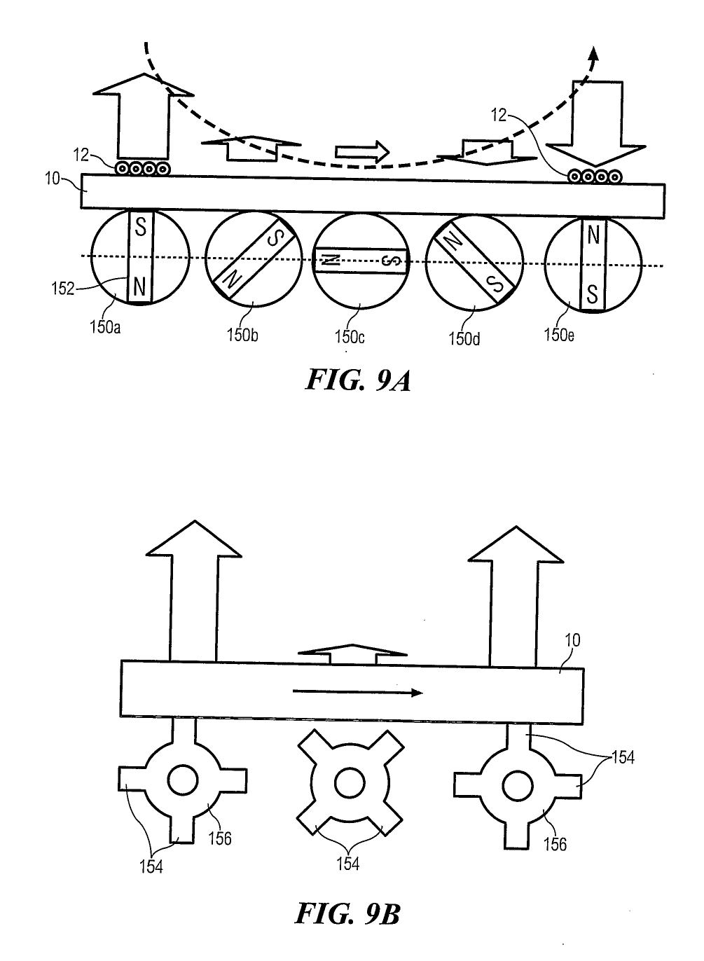

FIG. 9a and FIG. 9b are alternative embodiments of magnetic source carriers;

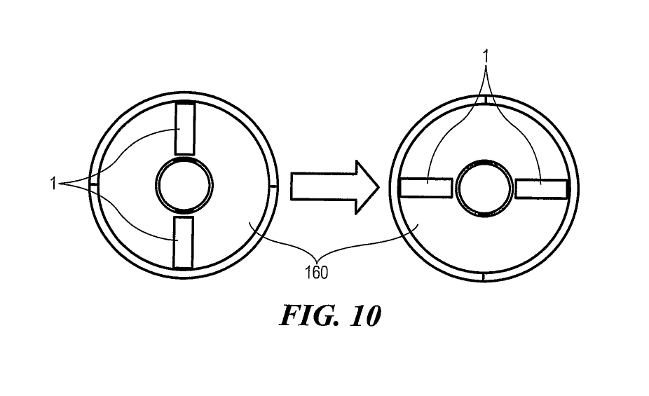

FIG. 10 is another illustration of an alternative embodiment where a magnetic source carrier has a dual pole magnetic structure.

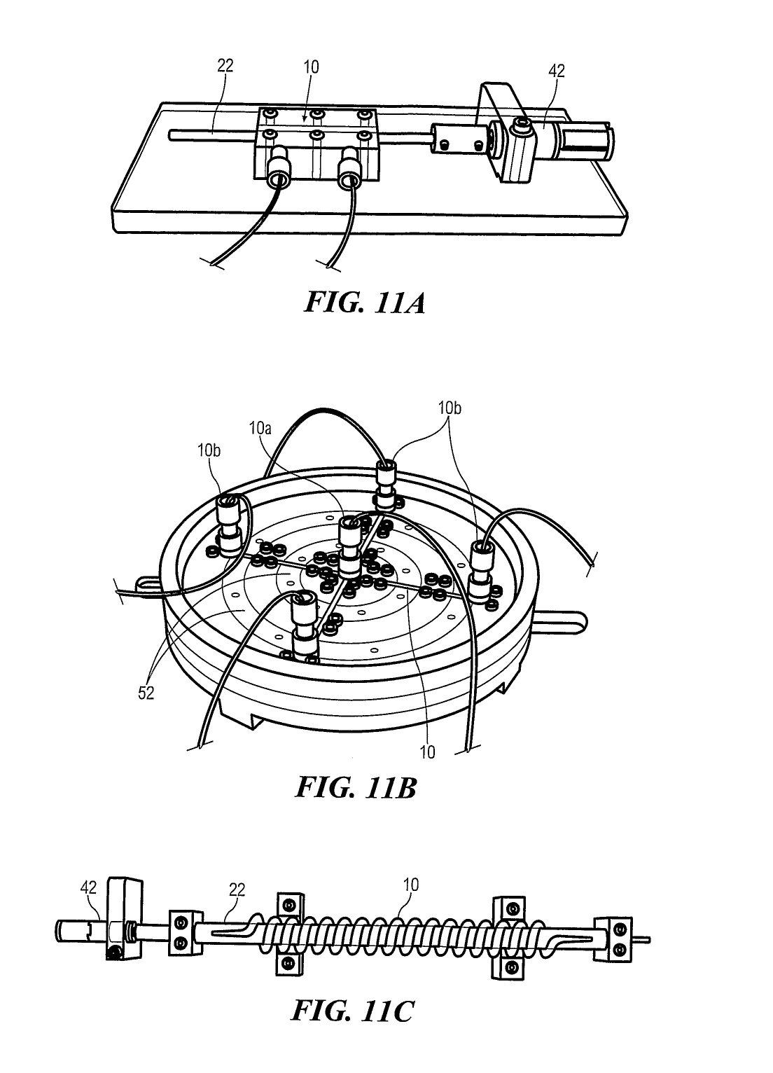

FIG. 11a, 11b and 11c are photographs of the embodiment of the invention as illustrated in FIGS. 3a, 7a and 3c, respectively;

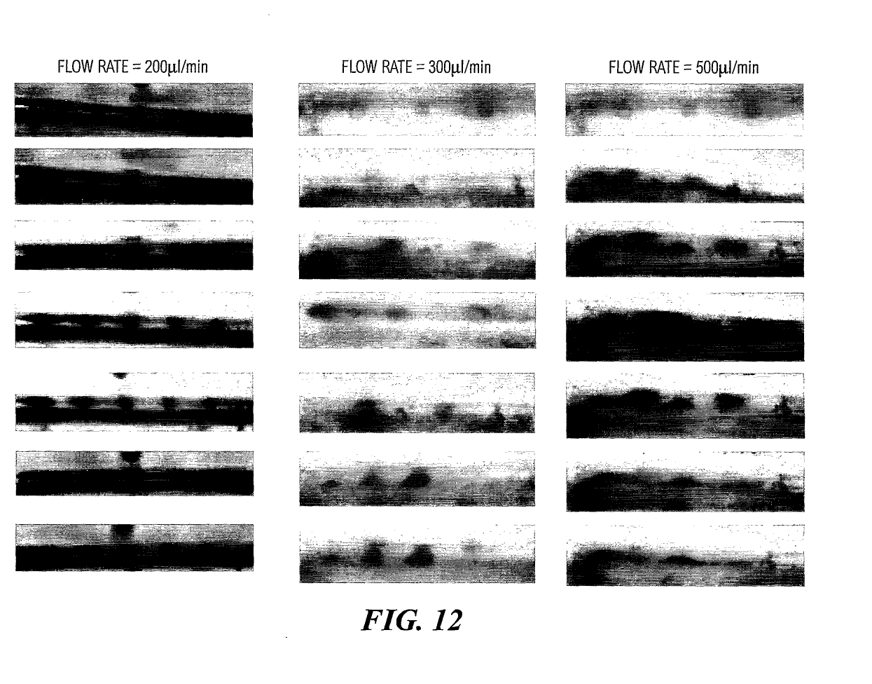

FIG. 12 shows snap shots of magnetic particle concentrations using the embodiment of FIGS. 2, 3 and 11a at different flow rates (200 μl/min, 300 μl/min and 500 μl/min;

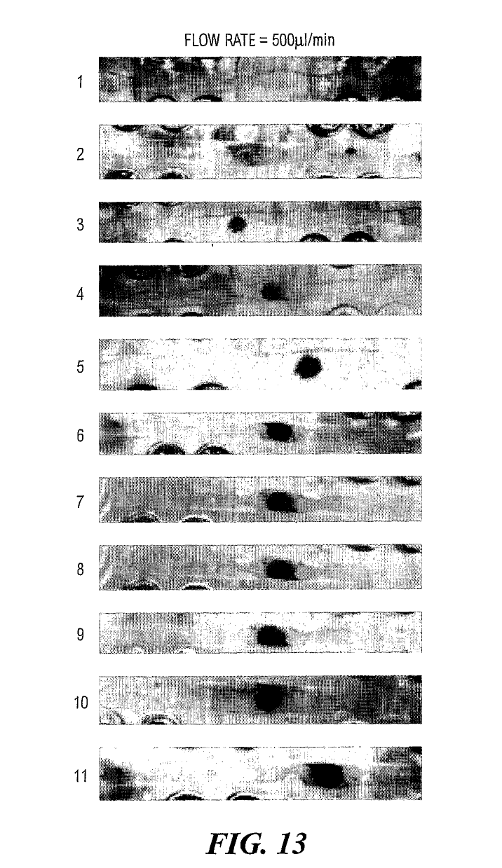

FIG. 13 shows snap shots of magnetic particles concentration using the embodiment of FIGS. 5, 6, 7 and 11b;

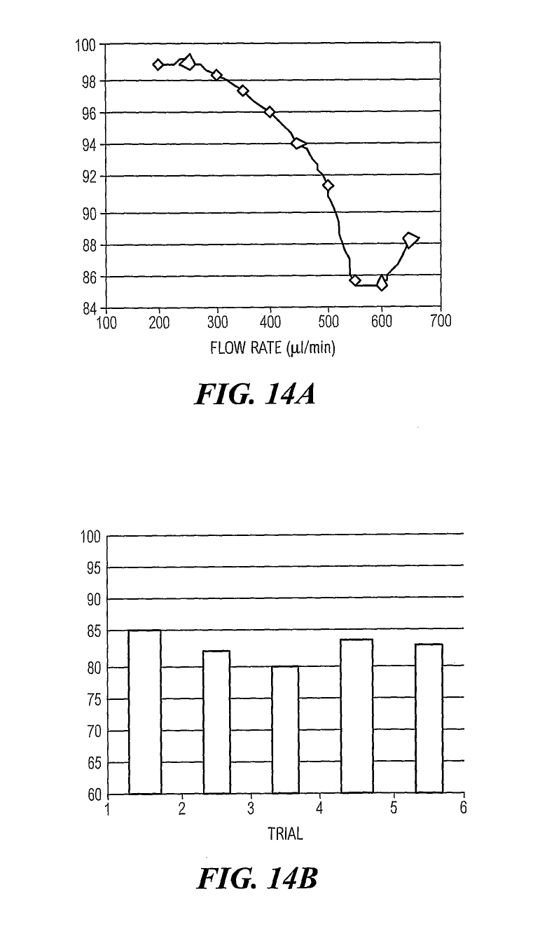

FIG. 14a shows a concentration efficiency of the system described by FIGS. 2, 3 and 11a at different flow rate of the sample in the fluidic channel and FIG. 14b shows estimated purification efficiency as measured by the system described by FIGS. 2, 3 and 11a; and

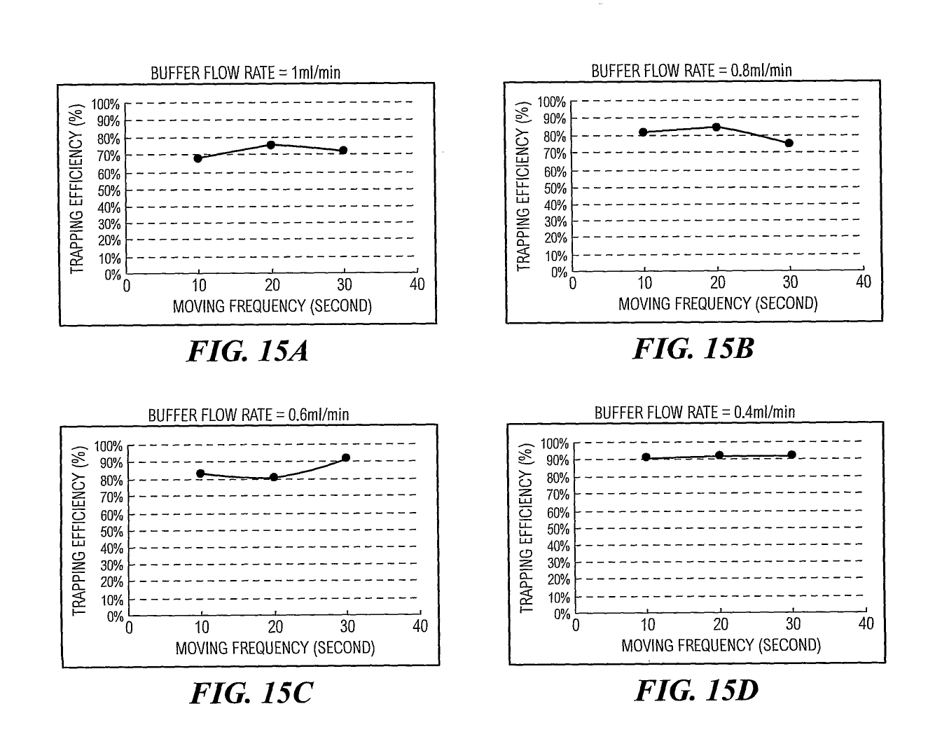

FIG. 15 shows a series of graphs that illustrate concentration efficiency as a function of the oscillation frequency at different flow rates using the embodiment of FIG. 8.

FIGS. 1a-1c shows the effects of different configurations of the channel—magnet pole interface and its corresponding effect on a magnetic particle within the channel. In FIGS. 1a-1c, the magnetic source 1 is shown at different orientations with respect to the fluidic channel 10. In FIG. 1a, the magnetic source 1 is at a vertical orientation with its south pole directly beneath the fluidic channel 10. At this time, the magnetic field produced by the magnetic source 1, as experienced in the fluidic channel 10, is at a maximum. Accordingly, the magnetic particles 12 are illustrated as being assembled or trapped at the bottom of the fluidic channel 10.

In FIG. 1b, the magnetic source 1 is rotated such that it is at an angle φ to the fluidic channel 10. At this instant, the magnetic field produced by the magnetic source 1, as experienced in the fluidic channel 10, is no longer at a maximum. As such, a magnetic particle 12a is seen to be dispersed as the decreased magnetic field is no longer able to hold all the previously assembled magnetic particles 12 any longer in view of the force exerted on the magnetic particles 12 due to the shear forces from the continuous flow within the fluidic channel 10.

In FIG. 1c, the magnetic source 1 is oriented horizontal to the fluidic channel 10. At this instant, the magnetic field, as produced by the magnetic source 1, and as experienced in the fluidic channel 10, is at a minimum. Accordingly, the magnetic field is no longer strong enough to trap the magnetic particles 12a and said magnetic particles 12a disperse and rejoin the continuous flow.

FIGS. 2a and 2b show a cylindrical shaped magnetic source carrier 22 with a number of magnetic sources 1 and 2 inserted in it, each adjacent magnetic source 1 and 2 being perpendicular to each other. In the cylindrical magnetic source carrier 22. The magnetic sources 1 and 2 are inserted inside the magnetic source carrier 22 with their longitudinal axis being perpendicular to the longitudinal axis of the carrier 22. In addition, and as shown, each consecutive magnetic source 1 is arranged in a manner such that it is perpendicular to its adjacent magnetic source 2 and, at the same time, both magnetic sources 1 and 2 are perpendicular to the longitudinal magnetic source carrier 22.

FIG. 3a shows a magnetic source carrier 22 with a fluidic channel 10 on top of it. The magnetic source carrier 22 is positioned directly beneath the fluidic channel 10 with its longitudinal axis parallel to that of the channel 10 as shown in FIG. 3a. The magnetic source carrier 22 is actuated by a motor (not shown) and spins in the direction indicated. When the magnetic source carrier 22 spins, this causes the magnetic field to vary between maxima and minima values along the length of the fluidic channel 10. The maxima and minima values occur between any two adjacent perpendicular magnets as shown in FIG. 2a and FIG. 3a, for example. Accordingly, magnetic particles 12 follow the magnetic field maxima, which shift between any two adjacent perpendicular magnets due to this spinning.

It should be noted that the magnetic particles accumulate (or concentrate) at the magnetic field maxima at locations when the poles of the magnetic sources (either 1 or 2) are facing the base of the fluidic channel 10. As such, when the cylinder spins and the poles of the magnetic sources 1 and 2 are no longer facing the base of the fluidic channel 10, the magnetic field experienced by the magnetic particles drops. Thus, the magnetic particles 12 are demagnetized and disperse back into the continuous flow system and are carried along till they reach the next magnetic field at maxima where said magnetic particles 12 are re-magnetized and assembled.

The magnetic particles 12 are typically made of super paramagnetic materials and as such, are capable of rapid re-magnetization and demagnetization. This is important as said it is optimal that the magnetic particles 12 exhibit no magnetic hysteresis or “magnetic memory” as this would prevent (work against) any applied magnetic field from assembling or dispersing the magnetic particles and translating across the fluidic channel in general. This translational motion of the particles is an advantageous effect of the device of the present invention as the magnetic particles 12, when translating between two adjacent magnetic sources 1 and 2, within a period of time (washing time T_{W}) provide a washing step for the particles (and hence the analyte) and this washing step is repeated continuously as the magnetic particle translates along the fluidic channel 10.

Efficiency of the device may be further increased by using, as shown in FIG. 3b, a meander shaped channel as used in conjunction with a plurality of magnetic source carriers 22. This embodiment of the fluidic channel 10 serves to increase the efficiency of the device of the present invention as the fluidic channel 10 is now elongated, i.e. a greater volume of analyte may be processed with more washing cycles thereby increasing the purity of the analyte obtained. Alternatively, a spiral form of the channel may also be used as shown in FIG. 3c. FIG. 3c shows a spiral shaped channel as used in conjunction with the magnetic source carrier of FIG. 2a. A magnetic source carrier 22 rotates in a central core of the spiral shaped fluidic channel 10.

FIG. 4a shows a schematic illustration of a trapping and releasing sequence of magnetic particles due to a magnetic field. The magnetic sources 1a, 1b and 1c are orientated such that their respective south poles are facing the base of the channel 10. As mentioned above, at the particular locations of the magnetic sources 1a, 1b and 1c along the length of the channel 10, a maxima magnetic field is established. Correspondingly, the respective maxima magnetic fields assemble the magnetic particles 12. As the magnetic source carrier (not shown) spins, the magnetic field at these locations drops sharply to a minimum until the magnetic sources are oriented with their north poles facing the channel, thereby generating a maxima magnetic field at these locations again.

During the transition time between the regeneration of the maximum magnetic field, the magnetic particles 12a behave as weak magnetic particles. In other words, this transition time allows the particles to be detached from each other, thereby decreasing the total concentration and consequently allows for a washing of each magnetic particle 12a releasing any impurity that may have been trapped during the magnetic particle assembly processes. FIG. 4b is an illustration of an embodiment of the invention that includes a magnetic source carrier 22, a fluidic channel 10 above the magnetic source carrier 22, and a motor 42 to generate the spinning motion of the magnetic source carrier 22 in order to vary the magnetic field applied to the fluidic channel 10. As in the embodiment of the magnetic source carrier shown in FIG. 2a, the magnetic source carrier 22 shown here also has magnetic sources 1 and 2 arranged in a similar fashion as described with respect to FIG. 2a.

FIG. 5a is a circular disc-shaped magnetic source carrier 52 with a number of magnetic sources 5 inserted in it and around its circumference. Unlike the magnetic source carrier 22 in the previous embodiment, a rotation of this magnetic source carrier 52 will maintain the orientation of the magnets and will translate them instead of rotating them with respect to the fluidic channel. FIG. 5b is a top view of the magnetic source carrier of FIG. 5a and shows the equidistant and uniform distribution of the magnetic sources 5 around the circumference of the magnetic source carrier 52. The use of this embodiment if the magnetic source carrier 52 in an alternative embodiment of the invention will be described later below with respect to FIG. 6.

FIG. 5c illustrates another embodiment of the magnetic source carrier 52 where the carrier 52 comprises a plurality of concentric rings 52a-52d that carry magnetic sources 5a-5d, respectively. The use of this embodiment if the magnetic source carrier 52 in an alternative embodiment of the invention will be described later below with respect to FIG. 7.

FIGS. 6a and 6b are illustrations of the magnetic source carrier 52 with a fluidic channel 10 on top of it. The magnetic source carrier 52 includes a plurality of magnetic sources 5 uniformly distributed around the circumference of the magnetic source carrier 52. In this embodiment, the magnetic source carrier 52 is supported by a supporting base 62. The fluidic channel 10 on top of the magnetic source carrier 52 is in the form of a cross, i.e. a central portion with four arms extending from said central portion. The arms extend over the magnetic source carrier 52 and therefore, also over the magnetic sources 5 carried by the magnetic source carrier 52, causes the fluidic channel 10 to be subject to any (maximum) magnetic field generated/applied by the magnetic source carrier 52.

In FIG. 6b, the fluidic channel 10 is rotated about its centre of rotation such that the axis Y-Y is also rotated, as compared to FIG. 6a. The fluidic channel 10 no longer extends over the magnetic sources 5 and is thus, also no longer subject to the maximum strength of the magnetic field. Instead, it may be expected that the magnetic field strength as applied to the now rotated fluidic channel 10 is at a minimum. It should be noted that the essential principle illustrated in this embodiment of the invention is one where the rotating/translating mechanism modulates the strength of the magnetic field (and therefore, the magnetic force) on the magnetic particles 12 in the fluidic channel 10 from maxima to minima.

FIG. 7a illustrates the above-described embodiment of the invention where the magnatic source carrier 52 includes concentric rings, a fluidic channel 10 and a motor 42 to generate the rotation motion in the magnetic source carrier 52. Referring to FIG. 7b, which illustrates a step-by-step operation of this embodiment of the invention, initially the magnetic particles 12 are trapped at the most inner ring (A). By rotating the magnetic source carriers 52a-52d together by an angle φ, for example, the magnetic source 5a in the most inner concentric ring of the magnetic source carrier 52a will shift from its location beneath the channel to a new location far enough from the channel while concurrently, the magnetic source 5b in the second carrier 52b will then be situated beneath the channel at (B). As such, the magnetic force vanishes at the first location (A) to be minima and increases to maxima at the location (B).

The magnetic particles 12 then move, as described earlier, from (A) to (B). This trapping/assembling, followed by releasing, constitutes a washing step and is repeated by the continuous rotation of the magnet carriers 52a-52d. After the magnetic particles 12 are released from the outermost magnetic source at (D), said magnetic particles 12 may be trapped in a reservoir with a stationary magnetic particle capture magnet (not shown).

FIGS. 8a and 8b are a schematic diagram and an illustration, respectively, of another embodiment of the invention. In this embodiment, the magnetic source carrier 84a and 86a oscillates about a mean position to modulate the magnetic field strength applied to the fluidic channel 10. The magnetic source carrier 86a may function in solo or in tandem with an additional carrier 84a, as illustrated in FIG. 8b. The start position of the carriers 84a and 86a may be with one carrier, such as carrier 84a for example, proximate to the fluidic channel 10 while the other (carrier 86a) is distal from said channel 10. By this arrangement, a maximum magnetic field is only applied on one side (either topside or lateral side) of the fluid channel 10, and correspondingly, the magnetic particles 12 will tend to assemble at the locations at which the maximum magnetic fields are applied (due to the magnetic sources 1a and 1b).

Subsequently, the carrier 84a will oscillate and move away from the fluidic channel 10 while concurrently, the carrier 86a oscillates and moves proximate to the channel 10, thereby applying a magnetic field on a corresponding (opposite) side of the channel 10. As such, since the maximum magnetic field is now applied to a corresponding side of the channel 10, the magnetic particles will be attracted towards said side. Thus, a dispersion of the magnetic particles takes place from the original side at which the maximum magnetic field (due to carrier 84a) was applied towards the present side of the channel where carrier 86a now applies the magnetic field. During the dispersion, as the concentration of magnetic particles 12 is lower, and due to the shear forces exerted on the magnetic particle 12 from the fluid flow in the channel 10, the magnetic particles 12 get “washed”, i.e. any impurities that are attached to the analyte to which the magnetic particle is bound to get washed away during the translation from one point of a maximum magnetic field to the next along the channel 10.

FIG. 8a is a schematic diagram of the path of the magnetic particles 12 in this embodiment of the invention. The magnetic sources 1a-1e may be from carrier 84a and magnetic sources 2a-2d may be from carrier 86a, for example. As such, and as described above, the washing step takes place as the magnetic particles 12 translate between the points at which the various magnetic sources (1a-1e and 2a-2d) apply maximum magnetic fields across the channel 10. In this embodiment, a magnetic particle capture magnet (or a fixed unmodulated magnetic source) 82 is placed at the end of the channel 10, or proximate to the outlet, or at any other location along the channel that is convenient for extraction. This magnet 82 assembles all the magnetic particles 12 previously washed and is adapted to be removable from the channel such that the magnetic particles (and their analytes) are also removed along with it, thereby completing the isolation step.

FIG. 9a and FIG. 9b are alternative embodiments of magnetic source carriers. In the alternative embodiment of FIG. 9a, the magnetic source carrier 150 includes a magnetic source 152. The carrier 150 is initially at position 150a at one end of the channel 10. At this position 150a, the magnetic source 152 is oriented vertically such that its south pole is closest to the channel 10 thereby applying a maximum magnetic field to the channel 10. Magnetic particles 12 are correspondingly attracted and assembled at the spatial location along the fluidic channel at which the maximum magnetic field is generated.

Subsequently, the carrier 150 rolls along the fluidic channel through positions 150b-150d before reaching position 150e. During the transition between position 150a and 150e (i.e. at positions 150b-150d), the magnetic field applied to the channel 10 is less than the maximum, and also ought to be insufficient to hold the assembled magnetic particles 12 at position 150a in place any longer. As such, the magnetic particles 12 will disperse into the continuous fluid flow and undergo the washing step as previously described with respect to the previous embodiments above.

Upon reaching position 150e, the magnetic particles 12 are once again subject to a maximum magnetic field as applied by the carrier 150, which is also at said position 150e. Accordingly, the magnetic particles 12 reassemble at the spatial location 150e, thus completing one washing cycle. This cycle may be repeated over the entire length of the channel 10 in order to improve the purity of any analyte attached to the magnetic particles 12.

FIG. 9b is an illustration of a further alternative embodiment where a magnetic source carrier 156 has a quadruple pole magnetic structure. In other words, it has four magnetic sources 154 uniformly distributed, each at ninety degrees to its preceding magnetic source. As above, when one of the four is oriented in the vertical position, it generates a maximum magnetic field, which functions as described above. Also as mentioned above, the magnetic source carrier 156 in this embodiment translates along the length of the fluidic channel 10. Unlike the previous embodiment, since the carrier 156 of this embodiment has four magnetic sources 154, the rate of modulation of the magnetic field, i.e. the frequency of successive maximum magnetic fields occurs at a higher rate then in the previous exemplary embodiment. Accordingly, more washing cycles may be generated with a single rotation of the magnetic source carrier 156 as compared to say the magnetic source carrier 150, for example.

FIG. 10 is another illustration of an alternative embodiment where a magnetic source carrier 160 has a dual pole magnetic structure. Essentially this means that there are two magnetic sources 1 located on the magnetic source carrier 160. Accordingly, about fifty percent less washing cycles may be generated with a single rotation of the magnetic source carrier 160 as compared to say the magnetic source carrier 156, for example.

FIG. 11a, 11b and 11c are photographs of actual embodiments of the invention as illustrated in FIGS. 3a, 7a and 3c, respectively. As described above, each embodiment includes the basic feature of a magnetic source carrier 22 and 52 including at least one magnetic source (not shown), wherein the magnetic fields generated by the respective magnetic sources, and as applied to their respective fluid channels 10, are modulated by a movement (spinning, rotation or oscillation) of the magnetic source carriers.

To test the devices efficiency for magnetic beads concentration and purification three solutions were prepared. These solutions are:

1. Magnetic particles suspension of specified dilution;
2. Non-magnetic particles suspension of specified dilution;
3. 1:1 mixture of magnetic & non magnetic suspension of above specified solutions

The concentration efficiency test has been done by passing solution (1) through the system and collecting the waste at outlet. To quantify the concentration efficacy, the relative absorbance of the waste samples was measured against the control sample (taken from the sample prior passing through the magnetic system) using a spectrophotometer. Alternatively, the number of beads before in the sample before and after injection to the system was counted using a haemocytometer. The concentration efficiency can be given by:

$$Concentration = ( 1 - \frac{Q 3}{Q 1} ) \times 100 \%$$

Q1: Number of the magnetic beads in the sample before the injection into the system
Q2: Number of magnetic particles that trapped in the system (concentrated)
Q3: Number of un-trapped magnetic particles

To measure the sample loss through the fluidic channel, a normalization test was done by passing sample (2) through the channel and collecting the waste at the outlet. The number of particles was quantified by counting the number of particles in the samples (from the outlet) and comparing it with a control sample using a haemocytometer. This gives an approximate measure of the loss of particles during typical run of immunomagnetic separation (IMS) experiment.

The purification efficiency of the system was measured by passing solution (3) through the system and collecting the waste sample at the outlet and using the haemocytometer the non-magnetic particles were counted and compared to the control sample by considering the loss. The purification efficiency can be given by:

$$Purification = ( 1 - \frac{Q 2 - q}{Q 1} ) \times 100 \%$$

Q1: Number of the non-magnetic beads in the sample before the injection into the system
Q2: Number of non-magnetic particles in the waste sample
q: Number of beads lost in system during the IMS experiments

FIG. 12 shows snap shots of magnetic particle concentrations using the embodiment of FIGS. 2, 3a, and 11a at different flow rates (200 μl/min, 300 μl/min and 500 μl/min;

FIG. 13 shows snap shots of magnetic particles concentration using the embodiment of FIGS. 5, 6, 7 and 11b;

FIG. 14a shows a concentration efficiency of the system described by FIGS. 2, 3 and 11a at different flow rate of the sample in the fluidic channel and FIG. 14b shows estimated purification efficiency as measured by the system described by FIGS. 2, 3 and 11a.

FIG. 15 shows a series of graphs that illustrate concentration efficiency as a function of the oscillation frequency at different flow rates using the embodiment of FIG. 8.

It should be noted that the exemplary embodiments described above merely serve to aid in the understanding of various aspects of the present invention. Accordingly, said various aspects of the present invention are not to be construed to as being limited to said exemplary embodiments, but rather, as defined by the claims that follow.

1. A device for washing and isolating magnetic particles from a continuous fluid flow in at least one fluidic channel having an inlet at one end and an outlet at another end, said device comprising:
at least one magnetic source carrier arranged proximate to the at least one fluidic channel, wherein the at least one magnetic source carrier is moveable between a first position and a second position; said at least one magnetic source carrier comprising:
at least one first magnetic source, and
at least one second magnetic source,
wherein a movement of the at least one magnetic source carrier to the first position places the at least one first magnetic source at a first spatial location along the at least one fluidic channel such that said at least one first magnetic source generates a maxima magnetic field at said first spatial location that attracts the magnetic particles from the continuous fluid flow and assembles said magnetic particles at said first spatial location; and
wherein said at least one second magnetic source is arranged in a spatial arrangement with respect to the at least one first magnetic source, such that a movement of the at least one magnetic source carrier to the second position places the at least one first magnetic source distal from the first spatial location such that said magnetic field at said first spatial location is at a minima and the magnetic particles disperse from said first spatial location, and the movement of the at least one magnetic source carrier to the second position places the at least one second magnetic source at a second spatial location, which is downstream from the first spatial location, such that said at least one second magnetic source generates a maxima magnetic field at said second spatial location that attracts the magnetic particles from the continuous fluid flow and assembles said magnetic particles at said second spatial location.

2. (canceled)

3. The device according to claim 1, wherein the magnetic source carrier comprises a cylinder arranged proximate to the fluidic channel, wherein the cylinder is moveable via a rotation about its central longitudinal axis.

4. The device according to claim 1, wherein the magnetic source carrier comprises a disc arranged concentric to the fluidic channel, wherein the disc is moveable via a rotation about its origin.

5. The device according to claim 1, wherein the magnetic source carrier comprises a platform arranged parallel to the fluidic channel, wherein the platform is moveable via an oscillation about a median axis.

6. The device according to claim 3, wherein the at least one first magnetic source and the at least one second magnetic source are in an equidistant alternating spatial arrangement along the central rotational axis of the cylinder with respect to each other, and each of the at least one second magnetic source is oriented to be perpendicular to its adjacent at least one first magnetic source.

7. The device according to claim 4, wherein the disc comprises at least one circular ring.

8. The device according to claim 7, wherein the at least one circular ring includes the at least one first magnetic source arranged along its circumference.

9. The device according to claim 7, wherein the disc further comprises another circular ring, concentric to the at least one circular ring, wherein said another circular ring includes the at least one second magnetic source arranged along its circumference.

10. The device according to claim 9, wherein the at least one circular ring and the another circular ring are moveable independent of each other.

11. The device according to claim 5, wherein the platform comprises a first and a second magnetic source carriage arranged such that the fluidic channel is positioned in parallel there between, and the fluidic channel lies along the median axis about which the platform oscillates.

12. The device according to claim 11, wherein the at least one first magnetic source is arranged at discrete points along the first magnetic source carriage and the at least one second magnetic source is arranged at discrete points along the second magnetic source carriage such that the arrangement of each consecutive at least one first magnetic source is distal to a gap between two consecutive at least one second magnetic sources of the second magnetic source carriage.

13. The device according to claim 12, wherein the first and the second magnetic source carriages oscillate independently of each other.

14. The device according to claim 1 further comprising a motor that drives the movement of the magnetic source carrier.

15. The device according to claim 1 wherein the at least one first magnetic source and the at least one second magnetic source are embedded within the at least one magnetic source carrier.

16. The device according to claim 1 wherein the at least one first and second magnetic sources comprise permanent magnets or electromagnets.

17. The device according to claim 1, further comprising at least one capture magnetic source proximate to the outlet of the fluidic channel.

18. A system for washing and isolating magnetic particles in a continuous fluid flow, said system comprising:
at least one fluidic channel having an inlet at one end and an outlet at another end; and
at least one magnetic source carrier arranged proximate to the at least one fluidic channel, wherein the at least one magnetic source carrier is moveable between a first position and a second position; said at least one magnetic source carrier comprising:
at least one first magnetic source, and
at least one second magnetic source,
wherein a movement of the at least one magnetic source carrier to the first position places the at least one first magnetic source at a first spatial location along the at least one fluidic channel such that said at least one first magnetic source generates a maxima magnetic field at said first spatial location that attracts the magnetic particles from the continuous fluid flow and assembles said magnetic particles at said first spatial location; and
wherein said at least one second magnetic source is arranged in a spatial arrangement with respect to the at least one first magnetic source, such that a movement of the at least one magnetic source carrier to the second position places the at least one first magnetic source distal from the first spatial location such that said magnetic field at said first spatial location is at a minima and the magnetic particles disperse from said first spatial location, and the movement of the at least one magnetic source carrier to the second position places the at least one second magnetic source at a second spatial location, which is downstream from the first spatial location, such that said at least one second magnetic source generates a maxima magnetic field at said second spatial location that attracts the magnetic particles from the continuous fluid flow and assembles said magnetic particles at said second spatial location.

19-34. (canceled)

35. The system according to claim 18, wherein the at least one fluidic channel is straight or meandering in shape between its inlet and outlet.

36. A method of washing and isolating magnetic particles from a continuous fluid flow in at least one fluidic channel having an inlet at one end and an outlet at another end, said method comprising:
applying a magnetic field from a first magnetic source at a first spatial location along the fluidic channel thereby attracting the magnetic particles from the continuous fluid flow and assembling said magnetic particles at the first spatial location;
applying a magnetic field from a second magnetic source at a second spatial location, downstream from the first spatial location along the fluidic channel, thereby attracting the magnetic particles from the continuous fluid flow and assembling said magnetic particles at the second spatial location;
moving the first magnetic source relative to the fluidic channel such that the magnetic field at said first spatial position decreases sufficiently to result in a dispersal of the assembled magnetic particles from the first spatial location back into the continuous fluid flow, and
moving the second magnetic source relative to the fluidic channel such that the magnetic field at said second spatial position decreases sufficiently to result in a dispersal of the assembled magnetic particles from the second spatial location back into the continuous fluid flow.

37. (canceled)

38. The method of claim 36 further comprising:
applying a magnetic field from an at least one capture magnetic source at a capture spatial location proximate to the outlet of the fluidic channel thereby attracting and assembling the magnetic particles from the continuous fluid flow at the capture spatial location; and
removing said magnetic particles assembled at the capture spatial location.
